(19) United States
(12) Patent Application Publication
(10) Pub. No.: US 2004/0030952 A1
(43) Pub. Date: Feb. 12, 2004

(54) Rambus based hot plug memory

(76) Inventors: Gary J. Piccirillo, Cypress, TX (US); Chris Wanner, Tomball, TX (US)

Correspondence Address: HEWLETT-PACKARD COMPANY, Intellectual Property Administration, P.O. Box 272400, Fort Collins, CO, 80527-2400, US

(21) Appl. No.: 10/636,330

(22) Filed: Aug. 6, 2003

Related U.S. Application Data
(63) Continuation of application No. 09/675,531, filed on Sep. 29, 2000, now abandoned.

(51) Int. Cl. H02H 3/05

(52) U.S. Cl. 714/7

(57) ABSTRACT

A computer system has at least one CPU, a host controller coupled to said CPU and one or more RAMBUS® repeaters coupled to the host controller. The host controller includes a memory controller integrated therein. Each repeater may have one or more RAMBUS® memory modules coupled to the repeater. The repeaters are used to provide sufficient distance between the host controller and the memory modules. If desired, multiple repeaters can be serially connected to provide extra distance if needed. If desired, one of the repeater/memory module(s) combination (“channel”) can be used for redundant data storage. The redundant channel permits the system to calculate the data that was stored on any one of the other memory channels. This feature is advantageous in the event one of the data channels experiences memory module failure. If a memory module fails, the other memory modules can continue to operate. Then, when the failed memory module is removed and replaced with a functional memory module, the system can calculate the data that was stored on the failed memory module and rewrite that memory module with such data.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to hot pluggable memory. More particularly, the invention relates to RAMBUS®-based hot pluggable memory. Still more particularly, the invention relates to hot pluggable RAMBUS® memory using repeaters to separate the memory modules from the memory controller.

2. Background of the Invention

Although computer systems today are generally quite reliable, computers nevertheless are not failure proof. Fortunately, many components in a computer system can be repaired or replaced. The memory devices in a computer are one example of replaceable components. Memory devices typically are provided as part of a module that connects to a circuit board such as the main system board (“mother board”). The ability to replace memory is the focus of this disclosure.

Once a memory device fails, it is first necessary for the computer system in which the failed part resides to detect the failure. Various techniques that are beyond the scope of this disclosure are used to detect memory device failures. How the system responds to a failed memory also varies from architecture to architecture. In older systems, a memory failure may have automatically made the entire computer system non-operational and have caused an error message to be displayed to the user that a memory error had occurred. The response by the user was simply to shut the system down altogether so that the defective device could be replaced. This approach increasingly is becoming less desirable particularly for server computer systems whose reliability and continuous 24-hour operation is vitally important to the business. For example, for obvious reasons it is highly undesirable for Internet service providers (“ISPs”) or other continuously operating and mission critical entities to be off-line for any time whatsoever.

Another response to a failed memory device that has been proposed and/or implemented in a commercially available product is to permit the system to remain operational, but to isolate the failed memory device. The system might simply cease reading from and writing to the failed memory device. This solution permits the system to continue running, which is desirable, but the system still must be shut off altogether to replace the memory device, which is undesirable as noted above.

A solution to these problems is permit the memory devices or modules to be “hot pluggable.” Hot pluggable means that the module can be removed and replaced with a new module while the computer system continues to remain fully powered and operational. Several factors must be considered in designing a computer system to have hot pluggable memory. For example, it is generally known that performance (i.e., speed, throughput, etc.) is increased when the memory devices are located as close to the memory controller and processor, which access the memory, as possible. Shorter trace lengths generally result in shorter delays and less clock and data signal skew. However, it may be difficult to physically access and remove a failed memory module if the memory modules are located in close proximity to the core system logic. The core system logic (i.e., CPU(s), host controller, memory controller, etc.) typically is located on the main system board. Because of numerous other components in the system, such as fans, power supplies, etc., the system board may not be easy to access. This problem is akin to locating an oil dipstick in an automobile down low in the engine behind other parts thereby precluding easy access to the dipstick without removing other parts. It would be much easier to have the dipstick easily accessible from the top of the engine compartment, as is usually the case. In a computer system, for memory to be easily removable, it may be desirable to separate the memory from its core logic by relatively long distances. Such distances, however, may impair the performance of the system because of the resulting longer trace lengths.

Accordingly, a computer system is desired that contains hot pluggable memory to avoid the problems noted above.

### BRIEF SUMMARY OF THE INVENTION

The problems noted above are solved in large part by a computer system having at least one CPU, a host controller coupled to said CPU and one or more RAMBUS® repeaters coupled to the host controller. The host controller includes a memory controller integrated therein. Each repeater may have one more RAMBUS® memory modules coupled to the repeater. The repeaters are used to provide sufficient distance between the host controller and the memory modules. If desired, multiple repeaters can be serially connected to provide extra distance if needed.

If desired, one of the repeater/memory module(s) combinations (“channel”) can be used for redundant data storage. The redundant channel permits the system to calculate the data that was stored on any one of the other memory channels. This feature is advantageous in the event one of the data channels experiences memory module failure. If a memory module fails, the other memory modules can continue to operate. Then, when the failed memory module is removed and replaced with a functional memory module, the system can calculate the data that was stored on the failed memory module and rewrite that memory module with such data.

### BRIEF DESCRIPTION OF THE DRAWINGS

For a detailed description of the preferred embodiments of the invention, reference will now be made to the accompanying drawings in which:

FIG. 1 shows a computer system in accordance with the preferred embodiment including hot pluggable RAMBUS® memory.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

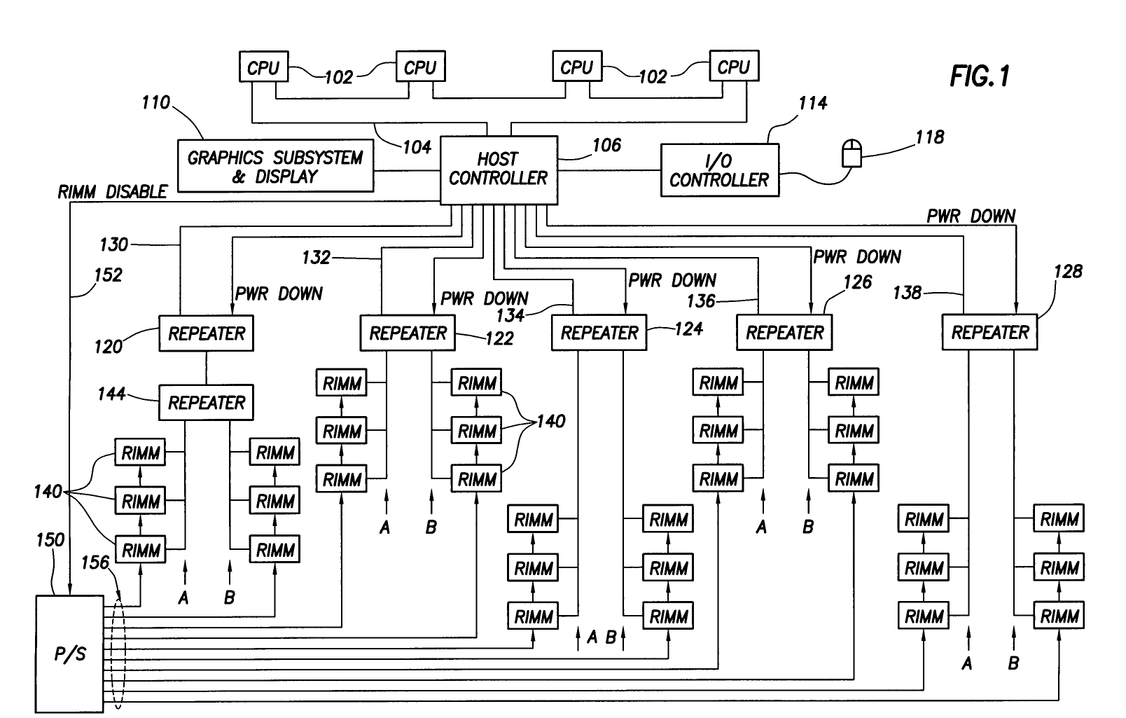

Referring now to FIG. 1, computer system 100 in accordance with the preferred embodiment comprises one or more central processor units (“CPUs”) 102, a host controller 106, a graphics subsystem and display 110, an input/output (“I/O”) controller 114, and an input control device 118. The computer system 100 also includes repeaters 120, 122, 124, 126, 128, memory modules 140 and a power supply 150 which provides power to the memory modules 140 as well as other to components in the system. The CPUs 102, graphics subsystem and display 110, I/O controller 114 and repeaters 120-128 couple to the host controller 106. The memory modules 140 couple to the repeaters as shown.

The CPUs 102 can be any suitable type of processor now known or later developed. The preferred embodiment of the invention is intended to be used not only with currently available CPUs, but also with CPUs that operate at higher speeds than CPUs currently available on the market. Although four CPUs 102 are shown in FIG. 1, it should be understood that any number of CPUs (i.e., one or more) can be used. As shown, all four CPUs 102 couple to the host controller 106 through a common bus 104. Alternatively, if desired, each CPU could couple to the host controller 106 via a separate bus.

The graphics subsystem and display 110 preferably includes any suitable graphics processor and display. The I/O controller 114 coordinates the flow of information to and from various I/O devices, such as the input control device 118 which, as shown, is a mouse. Other I/O devices include a keyboard, joystick, etc.

The host controller 106 coordinates the flow of information between the various devices shown. The host controller 106 thus functions as a focal point for commands and data to flow between the CPUs 102, the I/O controller 114, and the memory modules 140 via the repeaters 120-128. As such, the host controller includes various queues (not shown) which temporarily store messages. The host controller schedules the execution of the messages in a coordinated and efficient manner.

Referring still to FIG. 1, the memory modules 140 preferably comprise RAMBUS® inline memory modules (“RIMMs”). Alternatively, other types of memory modules, now known or later developed could be included in accordance with the principles expressed herein. As is commonly known, each RIMM 140 includes one or more RAMBUS® memory devices. Typically, a RIMM includes 4-16 (or more, e.g., 32) RAMBUS® memory devices soldered or otherwise attached to the memory module. When a memory device fails, preferably the entire RIMM containing the failed device is replaced. If desired, however, the RIMM 140 could be configured in such a way that individual memory devices could be removed and replaced, not the entire memory module.

For memory to be hot pluggable, the memory modules preferably should be readily accessible with as little effort as possible for the person replacing the memory. Preferably, the memory modules are located in close proximity to the core logic that interfaces with the memory for performance reasons as noted above. However, locating the memory modules in that manner may result in the memory modules being difficult to access. The preferred embodiment of the invention addresses these competing influences using repeaters 120-128 to remotely locate the memory modules relative to the host controller 106.

Each repeater 120-128 comprises a buffer for the associated channel. The electrical characteristics of RAMBUS® generally only permit a maximum of 32 RAMBUS® memory devices to be placed on each channel. This limitation is generally necessary to maintain a controlled impedance on the channel. Repeaters generally are used if more than 32 memory devices are needed for one channel. In that case, one of the 32 devices is a repeater. The repeater itself can permit up to 32 memory devices to be connected to it.

The preferred embodiment of the invention, however, uses the RAMBUS® repeaters for a different purpose. The RAMBUS® specification also places a relatively short distance requirement on how far away the memory devices can be from the host controller. To be able to locate the RIMMs 140 at greater distances from the host controller than that typically permitted by the RAMBUS® specification, the preferred embodiment of the invention uses repeaters to gain more distance.

As shown in FIG. 1, each repeater 120-128 connects to the host controller 106 via a separate RAMBUS® connection 130, 132, 134, 136, and 138, respectively. The length of connections 130-138 comport with the RAMBUS® specification. Each repeater then provides RAMBUS® connections to the various RIMMs 140. The length of the connections between the repeaters and the RIMMs 140 also comport with the RAMBUS® specification. However, as can be seen, the RIMMs 140 can be located at a distance from the host controller 106 that is the combined length of the connections between the RIMMs 140 and the repeaters and between the repeaters and the host controller. This total distance may exceed the RAMBUS® specification as mentioned above. Further, if even greater distances are needed, the repeaters can be serially linked together. For example, repeater 120 is shown linked to repeater 144 and repeater 144 provides the connections to the RIMMs 140. In general, one or more repeaters can be connected together to achieve whatever distance requirement is needed to make the RIMMs 140 as easily accessible as possible to replacing the modules. By using repeaters and being able to serially connect repeaters together for increased distances, the preferred embodiment shown in FIG. 1 advantageously provides considerable flexibility in design. For instance, the connection between the host controller and the RIMMs need not be predetermined and designed for a particular expected maximum distance. Instead, the RIMMs 140 can be located at any desired distance from the host controller 106 by using however many repeaters are necessary. As more repeaters are serially connected together, the round trip delay time for a memory request to pass from the host controller 106 through the repeaters to the RIMMs and back increases. Accordingly, the host controller 106 preferably is programmable to reflect the round trip delay time. For example, the controller may include a programmable register that can be written with the number of clock cycles comprising the round trip delay time. The controller 106 uses this delay information to communicate accurately with the RIMMs 140.

Each repeater 120-128 and 144 preferably includes at least one, and as shown two, independent channels (labeled as “A” and “B”). Each A and B RAMBUS® channel can couple to as many as three RIMMs 140 and each RIMM 140 can have between 4 and 16 memory devices. Each A and B RAMBUS® channel preferably comports with the RAMBUS® requirement of no more than 32 memory devices per channel.

Referring still to FIG. 1, if desired, one of the sets of RIMMs associated with a repeater can be used for data redundancy. For example, the RIMMs 140 associated with repeaters 120, 144, 122, 124, and 126 can be used as “data” storage memory while the RIMMs associated with repeater 128 can be used for redundancy (also referred to as “parity”). As such, the system 100 of FIG. 1 shows four data channels and one parity channel. The data stored on the parity channel preferably is the exclusive or combination of the data stored on the four data channels. Accordingly, each time a write operation is made to one of the four data channels, the parity channel is updated. The parity channel permits the system to calculate the data that was stored on any one of the data channels. This feature is advantageous in the event one of the data channels experiences a RIMM 140 failure. If a RIMM 140 fails, the other RIMMs can continue to operate. Then, when the failed RIMM is removed and replaced with a functional RIMM, the system can calculate the data that was stored on the failed RIMM and rewrite that RIMM with such data. In addition, both A and B channels can be powered down together. This embodiment may be used, if all of the RIMMs for both A and B channels and the associated repeater are fabricated on a single circuit card. The power to the entire card, including power to the repeater and all RIMMs, can be shut down by the power supply turning off a single power 150 feed to the card.

In operation, when a RIMM fails, a message preferably is presented to the user either via the graphics subsystem and display 110 or through a status indicator (not shown) on the front panel of the computer. The message is an indication to the user that a RIMM has failed and which RIMM has failed so that the user can replace the failed RIMM. Preferably, the channel (A or B) on which the failed RIMM 140 resides is powered down, as described below, upon the system detecting the failure. The remaining memory channels remain powered and continue operating normally. That is, the CPUs, for example, can continue issuing read and write cycles to the remaining powered RIMMs.

As shown in FIG. 1, each memory channel A, B preferably is powered via an independent power feed 156 from the power supply 150. Each power feed 156 can be enabled or disabled independent of the other power feeds. As such, each memory channel can be selectively turned off such as, for example, to replace a failed RIMM 140. When the system determines that a RIMM 140 has failed, the host controller 106, or other device if desired, asserts a RIMM DISABLE signal 152 to the power supply 150 to indicate to the power supply which power feed 156 to turn off. In response, the power supply 150 turns off power to the selected channel so that one or more of the RIMMs 140 on that channel can be removed and replaced. Further, the host controller 106 preferably asserts a PWR DWN signal to the repeater associated with the failed RIMM 140. This signal causes the repeater to drive low all data, address and control signals to the RIMMs so that the failed RIMM can be safely replaced without changing the new RIMM upon insertion into the system. Additionally, the host controller 106 itself may drive low all of its data, address and control signals to the repeater associated with the failed RIMM. This latter response may be beneficial if the repeater is also powered down in addition to the RIMMs, as discussed below.

Alternatively, both A and B channels can be powered down together. This embodiment may be used if all of the RIMMs for both A and B channels and the associated repeater are fabricated on a single circuit card. The power to the entire card, including power to the repeater and all RIMMs, can be shut down by the power supply turning off a single power 150 feed to the card.

In accordance with the preferred embodiment of the invention, the failed RIMM thus can be replaced while the computer system remains powered and operational. The user accesses the region of the computer containing the failed RIMM, removes the failed RIMM and inserts a new RIMM. Then, the user preferably indicates to the computer system that the RIMM has been replaced. This can be accomplished by pressing a special purpose button (not shown) on the computer or “clicking” on an icon or feature in a menu of choices on the display. Once the computer system is informed that the failed RIMM has been replaced, the system then regenerates the data that was on the RIMMs that were powered down. The data can be regenerated by exclusive OR'ing the remaining operational channels and the parity channel.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer system, comprising:
a processor;
a host controller coupled to said processor;
an input/output device coupled to said host controller;
a repeater coupled to said host controller; and
a plurality of memory modules coupled to said repeater;
wherein said host controller communicates with said memory modules through said repeater and said memory modules are hot pluggable.

2. The computer system of claim 1 wherein said memory modules comprise RAMBUS® inline memory modules (RIMMs).

3. The computer system of claim 2 further comprising a plurality of repeaters, each repeater coupled to one or more RIMMs.

4. The computer system of claim 3 wherein the memory modules coupled to each repeater can be powered down while the memory modules coupled to the other repeaters remain powered on.

5. The computer system of claim 1 further including a plurality of repeaters and wherein at least two repeaters are serially coupled.

6. The computer system of claim 1 further including two repeaters serially coupled together, and one of said repeaters is coupled to said host controller and the other of said repeaters is coupled to said plurality of memory modules.

7. The computer system of claim 1 further including a plurality of repeaters, each repeater coupled to said host controller and to at least one associated memory module, wherein one of said repeaters and associated memory modules is used by said computer system as redundant data storage in which the contents are a boolean combination of the memory modules associated with the other repeaters.

8. The computer system of claim 7 wherein said boolean combination comprises the exclusive OR operation.

9. The computer system of claim 8 wherein after replacing a memory module while said computer is powered on, said computer system regenerates the data associated with said replaced memory module.

10. A method for swapping RAMBUS® memory modules in a computer system, comprising:
(a) detecting a failed memory module;
(b) shutting down power to said failed memory module;
(c) alerting a user of said failed memory module;
(d) replacing said failed memory module with a new memory module; and
(e) informing said computer system that said failed memory module has been replaced.

11. The method of claim 10 further including regenerating data that was stored on said failed memory module and writing said regenerated data to said new memory module.

12. The method of claim wherein said RAMBUS® memory modules are coupled to a host controller by repeaters.
